(19) United States
(12) Patent Application Publication
(10) Pub. No.: US 2009/0030945 A1
(43) Pub. Date: Jan. 29, 2009

(54) METHOD AND SYSTEM FOR COLLECTING AND ANALYZING MEDICAL PATIENT DATA

(75) Inventors: George Andrew Miller, Seattle, WA (US); Ken Heilbrunn, Seattle, WA (US)

Correspondence Address: BLACK LOWE & GRAHAM, PLLC, 701 FIFTH AVENUE, SUITE 4800, SEATTLE, WA, 98104, US

(73) Assignee: DiagnosisPlus LLC, Seattle, WA (US)

(21) Appl. No.: 12/181,290

(22) Filed: Jul. 28, 2008

Related U.S. Application Data
(60) Provisional application No. 60/952,171, filed on Jul. 26, 2007.

(51) Int. Cl. G06F 17/30

(52) U.S. Cl. 707/104.1; 707/E17.009

(57) ABSTRACT

A method of generating a display reflecting some contents of a database includes retrieving values from the database, each value representing each of a plurality of factors determined to be indicative of a state of health. The values are analyzed to determine a first score indicating conformity with some identified first thresholds. Each of a plurality of first blocks for placement in a first echelon is colored based upon the first score. First scores are selectively combined to determine at least one second score based upon conformity with a corresponding second threshold. Each of the at least one second block is colored based upon the corresponding second score. The at least one second block is arranged in a second echelon of the display. The plurality of first blocks are then arranged to form a first echelon such that each of the first blocks is close to the second block that bases its second score upon that first block.

### PRIORITY CLAIM

This application claims the benefit of the filing date of U.S. Provisional Patent Application No. 60/952,171 filed on Jul. 26, 2007, which is herein incorporated by reference in its entirety.

### FIELD OF THE INVENTION

This invention relates generally to medical record keeping and, more specifically, to synthesis of patient condition and lifestyle in a report.

### BACKGROUND OF THE INVENTION

In contrast to many other branches of science, such as engineering, physics, and computer science in which solutions to problems can often be expressed in terms of equations, laws, and analytical functions, solutions to medical problems, analyses, and treatments are usually selected based on large collections of empirical facts related to each other in complicated ways. An adequate conclusion for a practical medical problem, such as the diagnosis of a disease, a general assessment of a patient's health, treatment, and outcomes analysis, can often be obtained only after all or most of the known facts have been carefully analyzed. As the number of facts is usually large and their correlations are often complicated, there is little in the field that allows for a correlation of all of the interrelations between various conditions and the lifestyle of a patient relative to those conditions.

Several solutions have been propounded to provide individualized profiles for patients. One such example is the system proposed in an article entitled “Function Requirements of a Computer-Based Patient Record System” written by G. K. Johnson. In the article, Johnson proposes a method and system for generating individualized medical profiles for patients (see entire document). Information collected from a patient to provide values for a subset of the set of input parameters (i.e., based on the information collected from the patient and the information input from the study a value (grade)) is provided in order to identify the correct study for the patient; matching the subset of input parameters to the one or more input parameters for each study in the medical database to produce a set of applicable studies (i.e., selection of relevant studies is based on the set of value and the other input for the study; an applicable study is selected to meet the needs of the specific patient). Johnson teaches an aid to diagnosis by isolating those studies most likely to produce a result that informs the diagnosis; it does not use that information to generate a profile for the patient to aid the patient in conforming the lifestyle to a regimen likely to improve a condition for which the patient may be at risk.

U.S. Pat. No. 6,581,038 (the “'038 patent”) teaches an automated method for generating risk evaluation parameters based upon current medical literature. A method of generating individualized medical profiles for patients is based on inputs provided by the patient and the use of those inputs with algorithms extracted from a carefully assembled subset of the relevant medical literature. As taught therein, both a method and a system require: 1) selecting medical literature for inclusion in a medical database based on a set of predetermined inclusion criteria; 2) extracting algorithms from studies in the selected medical literature for addition to the medical database, including compiling a set of input parameters, a set of output parameters, and a set of algorithms; 3) matching a subset of patient-specific input parameters to input parameters for each study in the medical database to produce a set of applicable studies; and 4) using patient-specific inputs with the algorithms in the applicable studies to generate an individualized medical profile.

The '038 patent, however, suffers from another huge deficiency—it does not rely upon the medical judgment of doctors to generate rules or algorithms for relating input parameters to generate individualized medical profiles, except to the extent such judgment is expressed in the medical journals. The teaching of the '038 patent is largely for the purpose of minimizing provider contact, substituting therefore the extracted medical literature. By relying upon computers to synthesize the data, even of selected medical literature, conflicting literature is not well addressed. Contradictory studies are not well-resolved by the generation of algorithms and optimal information is not reflected in the profile so generated.

The '038 patent is based upon an encyclopedic and uniformly constructed patient record. Without such suitably uniformity, the system of the '038 patent cannot apply the rules derived from the medical literature because the suitable “if-then” algorithms the literature defines will necessarily need flags to satisfy the “if” condition.

Additionally, the '038 patent, as taught, is principally an aid to a treating physician in ordering tests or treatments; its output, as described, will do little to reporting a health status rapidly to the patient or to a primary health care provider at a glance.

### SUMMARY OF THE INVENTION

A method of generating a display reflecting some contents of a database includes retrieving values from the database, each value representing each of a plurality of factors determined to be indicative of a state of health. The values are analyzed to determine a first score indicating conformity with some identified first thresholds. Each of a plurality of first blocks for placement in a first echelon is colored based upon the first score. First scores are selectively combined to determine at least one second score based upon conformity with a corresponding second threshold. Each of the at least one second block is colored based upon the corresponding second score. The at least one second block is arranged in a second echelon of the display. The plurality of first blocks are then arranged to form a first echelon such that each of the first blocks is close to the second block that bases its second score upon that first block.

These and other examples of the invention will be described in further detail below.

### BRIEF DESCRIPTION OF THE DRAWINGS

Preferred and alternative examples of the present invention are described in detail below with reference to the following drawings:

FIG. 1 is a block diagram depicting a method of transacting with a database to generate a display a display;

FIG. 2 is a dialogue box to enable an automated patient questionnaire;

FIG. 3 is a dialogue box to enable a provider to enter objective data into the database relative to the patient;

FIG. 4 is a dialogue box to enable an expert to generate suitable thresholds to define algorithms for analysis of patient related data; and

FIG. 5 is a display of patient related data generated according to the inventive method.

### DETAILED DESCRIPTION OF THE PREFERRED EMBODIMENT

For the purpose of explaining the method and the system as detailed herein, a number of conventions are adopted. Within this document, “provider” will be used to describe either a medical doctor or other practitioner, such as, without limitation, physicians, physicians' assistants, nurses, or other care providers. When used, the term “block” will be used with regard to any element that contains cumulative information about a group of facts. A “fact” is an indivisible piece of information about the patient, the data for which is usually entered by either of the patient or the provider. A “value” refers to a specific option from a list of integers used to characterize the blocks. Values can be coded as colors, grades, and so on. A “weight” refers to a numeric measure of relative importance for a specific value of a fact or block.

Weights and values may be either static or dynamic. “Static” is used to indicate that which is unchanging or hard to change. Age of a patient is static though gradually changing fact. In contrast, “dynamic” refers to that which changes frequently or can be easily modified and reconfigured.

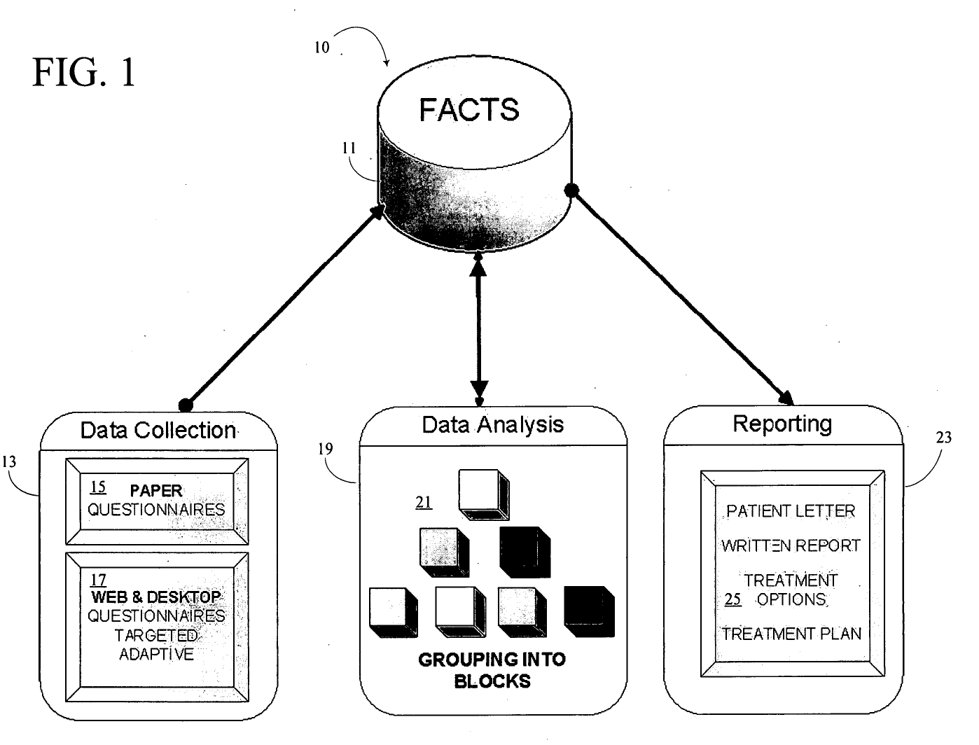

Referring to FIG. 1, a method 11 is shown in a block diagram. A relational database 11 is a central element of the system and accordingly, the method 10 is portrayed as three distinct phase: data collection 13; data analysis 19; and report 23 each in interaction with the database 11.

Collecting Data

The process of collecting data has some inherent challenges. First, it is necessary to know what data to collect. In counterdistinction to existing methods, the instant method relies upon inventories or questionnaires by which the patient provides the principal data that drives the method 10, rather than upon records stored in a uniform manner.

In a non-limiting embodiment, the known conditions of the patient are used to generate specific targeted questionnaires. Many traditional questionnaires used in medical practice gather large amounts of data that are not necessarily consistent with current research and are not targeted towards generating reports and specific treatment. Traditional questionnaires are rarely targeted to the specific disease, demographic, and lifestyle subclasses of patients and are therefore unnecessarily long and hard-to-follow. Most traditional medical questionnaires are static. Reliance upon a static questionnaire prevents exploiting questions that are reflective of ongoing advances in medical research and clinical practice. In view of the ongoing and accelerating changes in medical science, a questionnaire may become outdated in several years, perhaps even sooner. In the embodiment, population of fields within the database 11 occurs using targeted or adaptive patient questionnaires. By virtue of relying principally upon patient responses to questions within targeted questionnaires, incomplete or otherwise flawed patient data recorded in charts may still additionally aid the healthcare provider to make partial or full assessments and treatment recommendations.

An example of a static questionnaire is the Minnesota Multiphasic Personal Inventory (MMPI), typically interpreted using an extended score report, which includes data on the newest and most psychometrically advanced scales—the Restructured Clinical Scales (RC scales). Because the MMPI is one of the most studied questionnaires in the psychiatric field, there exist more than one alternate means of interpreting the data. The computer scoring programs offer a range of scoring profile choices including the extended score report, which includes data on the newest and most psychometrically advanced scales—the Restructured Clinical Scales (RC scales). Some questions have been raised about the RC Scales and the forthcoming release of the MMPI-2-RF, which eliminates the older clinical scales entirely in favor of the more psychometrically appealing RC scales. The replacement of the original Clinical Scales with the RC scales has not been met with universal approval and has warranted enough discussion to prompt a special issue of the Academic Journal of Personality Assessment (Volume 87, Issue 2, October 2006) to provide each side with a forum to voice their opinions regarding the old and new measures. In any regard, a static questionnaire such as the MMPI forces the patient to answer a number of questions that are not currently related to the RC scales, and, as the study of medicine advances, the static questionnaire fails to incorporate better questions, but rather makes better informed interpretations of either poorly or inadequately formulated questions.

The data collection 13 is effected through the formulating and interpreting of questionnaires answered by patients. The data collection 13 may be accomplished alternatively, through either paper forms 15 or interviews based upon the paper forms 15, in any of live, recorded and voice recognition-based collection, or upon telephone input. Alternately, the data collection may be effected through automated means 17 based upon either desktop or web interfaces tied to the database 11.

The questionnaires are, in one nonlimiting embodiment, built using specifically designed administrative interfaces. These interfaces make it possible to easily update or modify the questionnaires. The data collection 13 may include two parts: a preliminary form which allows the system to classify the patient, and a detailed questionnaire used to obtain all the information assistive to a specific type of assessment. The questionnaires can be also adaptive. They can be filled out for collection of data electronically, for example, using the recording responses of the desktop or web interface. Based upon the recorded responses, a distinct series of questions may be presented to evoke further responses to more exhaustively detail a patient's current state.

Thus, the invention may include both adaptive and targeted questionnaires. An adaptive questionnaire is a questionnaire in which the occurrence of a specific question depends on the answers to all or some of the previous questions. A targeted questionnaire is a questionnaire that is selected based on known facts about the patient, the known fact originating either from medical charts or from simple screening questions prefatory to either of the questionnaires.

Analysis of Data

Ultimately, the method 10 works to populate a display 21 according to rules stored within the database 11. These rules are readily changed, through use of the administrative interface, to reflect current medical knowledge as that knowledge evolves. The populating of the display includes, in one embodiment, updating the rules which drive an analytical engine within the database 11. Rather than to serve on a reviewing board for selecting relevant medical literature, one or more doctors, professors, or scientists (collectively “experts”) author rules, also referred to herein as algorithms, as those rules are formulated by the experts based upon the latest research results and clinical practice recommendations in a particular field of healthcare.

The display 21 is based upon the hierarchal grouping of data to form a number of suitably colored blocks such that the display 21 includes these blocks in the form of a two- or three-dimensional geometric shape, such as a spiral, a ramp, a tree, a triangle, a cone, or a pyramid. The three-dimensional shape (in this nonlimiting example, a two-dimensioned triangle) in which blocks at each higher level reflect the poignant data contained in the blocks at lower levels of the hierarchy.

Several readily apparent advantages inure in the use of such a display 21. One such advantage is that of provider recall. To assure the integrity of the data within the database 11 upon which the display 21 is based, a provider may readily recall any iteration of the display 21 to compare the resulting colored pattern to the provider's own assessment of the patient's state of health. Once the patient data is entered in the database, a first iteration of the display 21 can be formulated to be examined by the provider. Every question answered by the patient is mapped to an appropriate fact in the database. The database also contains additional facts that correspond to the information entered from the patient's own chart or the provider's knowledge of the patient.

Comparing the results of the administered questionnaire to the facts contained in the database 11 by means of the expert formulated algorithms is, herein referred, to as analysis occurring in the analysis block 19. Once the analysis is complete, the provider reviews the resulting display 21 and where a discrepancy is noted, reviewing patient responses upon which the coloration of the block is based. Once any discrepancies are suitably addressed or noted by the provider, the display 21 is finalized according to the patient's responses as tempered by the provider's insights and observations, and corrections based upon those insights and observations.

A third block of the method 10 is the reporting block 23. Once the display 21 is finalized, a printed version of the display 21 is generated for purposes of the chart and for sharing with the patient both the current state of the patient's health and prospective care including changes in patient habits. To facilitate the sharing of data and formulation of chart notes, the database will automatically retrieve text strings to generate the reports according to such specifications and format as the provider may designate. The specifications and format of the reports can also be readily configured by the provider through interaction with the administrative interface. The reports produced by the system can be further modified and edited by the provider if desired.

The graphic display 21 has a number of advantages over the simple printed report of current practice. As configured, the display 21 presents a large number of interrelated facts about a patient and allows immediate communication of those facts to the patient and provider in simple visual format aids. The healthcare provider is greatly aided in formulating a medical diagnosis and a case-specific assessment of each patient's health by the inventive display. Because the relevant algorithms for analyzing the data are configured to pivot upon only relevant issues the data present, unlike numeric presentations of data, no need exists for including a normal range for the data. Similarly, where additional facts, such as the taking of certain medications, might shift the range of what would be considered normal, the algorithms can be suitably tailored such that the color shift will only occur based upon the whole of a constellation of relevant facts.

Additionally, the display 21 serves to communicate between the patient and the provider. The use of the display 21 or a series of displays 21 taken at regular intervals becomes even more effective. Not only providing a static “snapshot” of the patient's state of health, the series of displays 21 serve as an analog to a “movie” yielding a feedback loop for the patient. Difference in the series of displays 21 allows the patient to appreciate the dynamics of the provider's treatment or the patient's own compliance with treatments. Noting changes in the display 21 over time teaches the patient about the effects upon the patient's state of health relative to elements of lifestyle, environment, diet, drugs, exercise, or other such elements as may be involved in disease treatment. Teaching patients the effect of their compliance is helpful to increase actual compliance by the patient with treatment recommendations from the health care provider. In the same manner, the display 21 provides a quick, intuitive means of updating the patient and the health care provider on the current state and progress, positive or negative, since the generation of the last display 21 of the patient's condition via color, or in another embodiment, via a shape of the apex of the triangle or other geometric shape.

The display 21 may also be used as a screening tool for patients who may be at risk for a particular disease. Coloration patterns within the display 21 may suggest or indicate at-risk states for which the patient may not have been sufficiently tested or diagnosed, thereby focusing the healthcare provider's attention on the testing that may further determine the state of the patient's health.

The System

The system can be used for short- and long-term storage of patient data and information, for performing individual patient data analysis on a specific disease or medical condition, for displaying the state of the patient's disease or condition at a particular moment in time, and for generating reports to provide a diagnostic assessment and/or to recommend treatments for the disease. The system can be configured to exist and run on an individual personal computer or workstation as well as in an online application where all functionality and interfaces are accessed through an Internet browser.

A relational database resident on a server system stores data, rules, and interfaces and controls the process flow and user interfaces. As it exists, the relational database has two different interfaces for purposes of interaction with the database. The first of these is for the providers and will be referred to here as the administrative software interface for configuring and managing every component of the system. A second interface may be either a remote client or may be based upon a website for interaction having the interface generated by a web browser, facilitating user-friendly data collection, data analysis, and reporting.

Because server systems are well-known in the art as are the use and deployment of relational databases, novel dialogue boxes will be discussed to show interaction with the database and server, rather than the mechanics of the server itself.

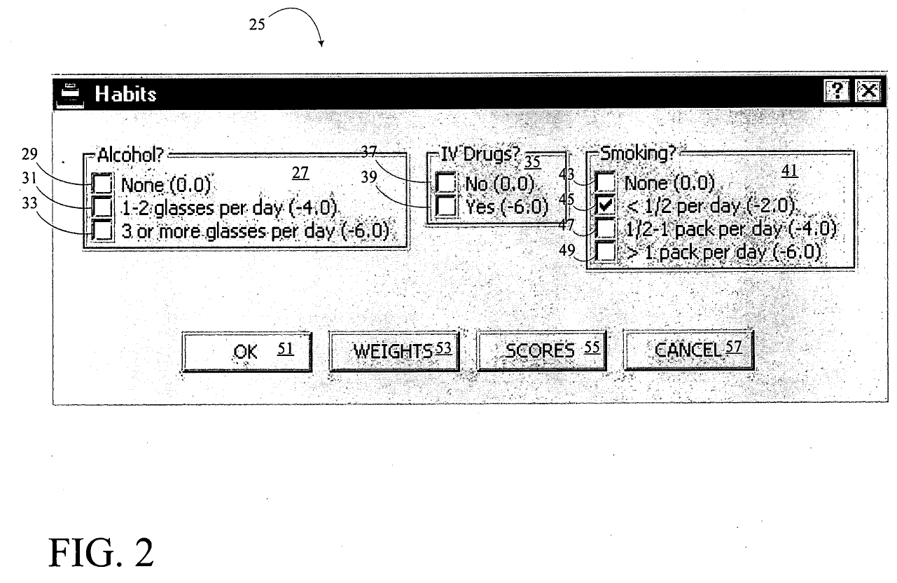

FIG. 2 depicts a nonlimiting and exemplary dialogue box 25 related to and entitled “Habits”. The dialogue box 25 is typical of those necessary for presentation and answering individual questions of the earlier discussed questionnaires. Because the questions seek quantifiable indications, very similar to what are commonly known as “multiple choice” questions, when such questionnaires are administered in paper form, a radio button is a preferred but not limiting choice in several embodiments.

A radio button or option button is a type of graphical user interface widget that allows the user to choose one of a predefined set of options. They were named after the physical buttons used on car radios to select preset stations—when one of the buttons was pressed, other buttons would pop out, leaving the pressed button the only button in the “pushed in” position.

Radio buttons are arranged in groups of two or more and displayed on screen as, for example, a list of circular holes that can contain white space (for unselected) or a dot (for selected). Adjacent to each radio button is normally shown a caption describing the choice that this radio button represents. When the user selects a radio button, any previously selected radio button in the same group becomes deselected. Selecting a radio button is done by clicking the mouse on the button, or the caption, or by using a keyboard shortcut.

In a presentation of a first question 27 relating to daily alcohol usage, three radio buttons 29, 31, 33 are presented to facilitate the collection of an answer. The first radio button 29 is provided to indicate abstinence from alcohol. The second radio button 31 indicates a moderate use of 1 to 2 glasses per day and indicates that according to algorithms that are themselves nonlimiting and exemplary, the indication of moderate use will result in the loss of four points. The third radio button 33 indicates a heavier alcohol usage of 3 or more glasses per day and is scored with the loss of six points.

A second question 35 relates to the use of intravenously injected drugs and is presented with two radio buttons 37, 39. The “no” button indicates abstinence and bears a “0” score. The “yes” button allows a patient to indicate use and because of the debilitating effects, according to the current exemplary algorithm, a “yes” answer is scored with the loss of six points, equal to heavy alcohol use.

A third question 41 is presented and accompanied by four radio buttons 43, 45, 47, 49 to garner a response from the patient. A first radio button 43 indicates abstinence from tobacco and is scored as neutral. A second radio button 45 indicates smoking consumption of less than a half a pack per day and is assigned a score of the loss of two points. A third radio button indicates use of between a half a pack and a full pack per day and is scored with the loss of four points. A fourth button indicates use of greater than a pack a day and is scored with loss of six points.

The dialogue box 25 also, in this exemplary embodiment, includes four graphic “push buttons” 51, 53, 55, 57 used to relate the responses for the patient in responding to the questions 29, 37, 41. The “OK” push button 51 simply records the responses and closes the dialogue box. The “weights” push button 53 causes the database to reveal to the patient any coefficient multiplier that will be assigned to each question in the course of recording any of the scores attendant to the questions 29, 37, 41, while the dialogue box persists after clicking on the “weights” push button. Pressing the “scores” push button 55 gives the patient a cumulative score for the currently reflected answers by the patient to each of the questions 29, 35, 41, and, as with the “weights” push button 53, the dialogue box persists upon clicking on the “scores” push button 55. The remaining push button 57 is labeled “cancel” and clears the selections and closes the dialogue box 25. While the “Habits” dialogue box 25 has been shown and explained herein, the principles set forth in the discussion apply with equal vigor to any of the questions necessary for the questionnaires, whether they are targeted, adaptive, or traditional in their format. Grouping of questions by topic, as shown herein, is not an essential quality of the invention and any group or individuation of the questions that is calculated to evoke reliable responses may be used with equal facility.

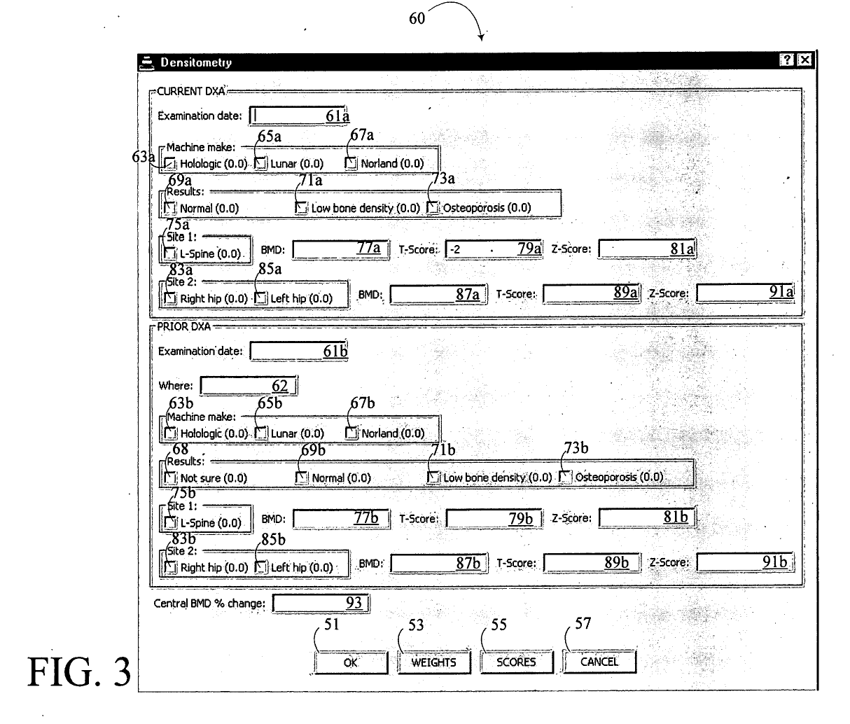

Referring now to FIG. 3, a second sort of dialogue box 60 is configured to enter objective data into the database 11 (FIG. 1) for further configuration of the resulting display 21 (FIG. 1). In this nonlimiting embodiment, objective data from two bone density reports are reflected in the dialogue box 60. The objective data such as test results and known medications is as important as the subjective data.

In the dialogue box, the most recent bone density examination is paired with an earlier examination for entry into the database. For purposes of description, in FIG. 3, use of a reference number such as the Examination Date fill in box 61 shall include both of 61a and 61b as each are identical except with regard to which of the two examinations are reported at the fill in box 61. Thus, the dialogue box 60 includes a fill in box 61 for the date of each of the two examinations.

At a fill in box 62, the provider or an agent of the provider supplies the location of the prior examination. Radio buttons 63, 65, 67 allow the provider or provider's agent to designate the brand name of the machine uses for examination.

The results of the examination are reported by means of radio buttons 68, 69, 71, 73. An ambiguous report is set forth at the radio button 68. If no discernable osteoporosis is noted, the radio button 69 suitably notes that impression. If some low bone density is noted, the radio button 71 is selected. Where full osteoporosis is noted instead, radio button 73 is provided for reporting such a finding.

Quantitative results are extremely important in noting progress and, where they reflect an abnormal or unexpected progress of the disease, may trigger the use of adaptive questionnaires directed at potential causes for the progress of the disease. Here, fill in boxes 77, 79, 81, 87, 89, and 91 are provided to receive the actual scores for each of the respective tests BMD, T-Score, and Z-score. Radio buttons 83, 85 enable description of the test site, whether right or left hip. A simple check box 75 is provided to confirm the examination at the lumbar region of the spine. At a results box 93, the numeric percentage of change between the two tests is displayed to the provider or provider's agent in order to act as a check for mistyped results and to inform the provider or provider's agent of the progress of the disease noted between the dates of the tests. As before, the push buttons 51, 53, 55, 57 labeled respectively “OK”, “Weights”, “Scores”, and “Cancel” function as set forth above.

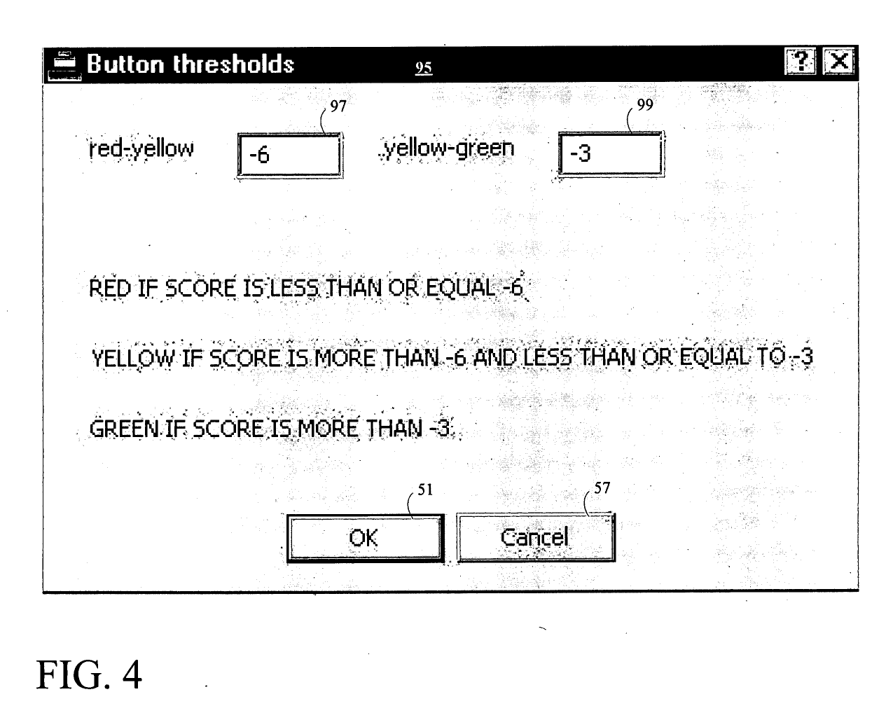

Referring to FIG. 4, a dialogue box 95 is provided to allow an administrator, the provider, or agents of the provider to suitably conform the algorithms that color the boxes in accord with certain scoring norms as the medical community, through published literature and through practice have come to recognize relations between various behaviors and a patient's general state of health as well as relationships between medicines, treatments, and even genetic conditions with a state of heath. Dialogue boxes such as the dialogue box 95 are exemplary for a means of authoring algorithms without requiring programming skills. By making the crafting of algorithms accessible to those experts who lack expertise in programming, much less of a threshold stands between the best and brightest providers and algorithms that reflect their expertise. In this fashion, the use of the dialogue boxes 95 in crafting algorithms allows a true multiplication of medical forces in assessing the patient's state of health.

In this particular nonlimiting example, the dialogue box is used to set threshold levels for the coloration of a box based upon an aggregate score relative to one of the factors used to generate the display 21 (FIG. 1). Thus, for this particular example, a score of −6 or less is determined by the expert to be a dangerous state of health with regard to that factor. Given the determination, the expert has set the score for the red-yellow transition to be −6 in a block 97. Similarly, the expert has determined that a score of −3 properly reflects transition from an “at risk” status to a normal status. Accordingly, the expert has placed a score of −3 in a block 99, thereby to configure the relevant algorithm to suitably color the block in response to the score a patient achieves with reference to the subjective and objective values stored in relation to the patient in the database.

To suitably explain the method of populating a display and the display of an overview of a patient's health, a non-limiting example showing a display determining a patient's risk of suffering a fracture attributable to osteoporosis and of formulating appropriate prevention and treatment suggestions and follow-up. The same system can readily be adapted for other “at risk” situations such as diabetes, nutritional issues, kidney function or a host of other health issues. The method of populating the display 21 and the display 21 are also readily adapted to non-health issues. For example, project tracking is readily reflected in a chart based upon similar rules. Maintenance of capital structures can also be similarly charted.

The Display and Analysis

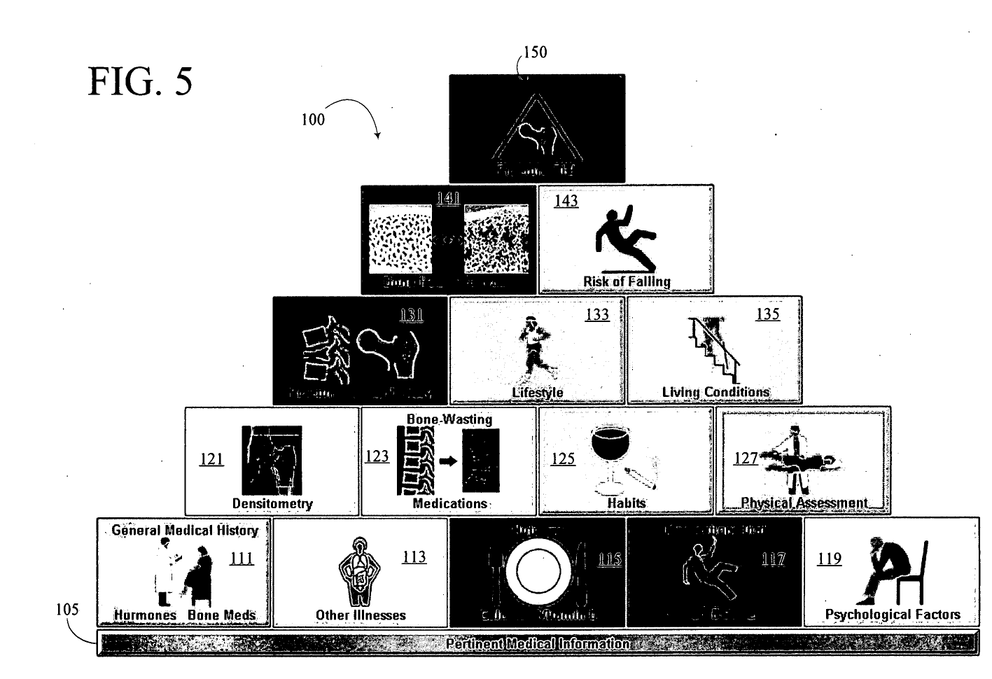

Referring to FIG. 5, the display 100 (shown as 21 in FIG. 1) is shown in greater detail. By way of overview, the display 100 is made up of blocks arranged in a pyramidal configuration such that the coloration of each block in a higher echelon of blocks is the result, at least in part, of conditions that colors of blocks of the lower echelon reflect. In this nonlimiting embodiment, blocks are colored in three colors adopted from commonly known traffic control conventions. Red is used to indicate danger or importance relative to the patient's state of health. Yellow is a more moderate warning indicating that the patient is at risk but not to the extent indicated by the use of a red coloration. Finally, where a patient exhibits behaviors or conditions that are within normal limits, the green color is used to color the block.

While other conventions can be suitable used while practicing the invention, the red, yellow, green convention is the presently preferred embodiment as it presents a clear and unambiguous indicator which is extremely useful in the context of changing patient behavior. The use of, for example, a full red-orange-yellow-green-blue-indigo-violet spectrum might convey a greater number of health states over the red-yellow-green of the presently preferred embodiment. Patients often react to the greater number of spectral states by being fully satisfied with their progress at a lesser rate because of the greater number of transitions a fuller spectrum provides.

Referring to FIG. 5, the exemplary display 100 is shown as a pyramid of blocks, though any hierarchical structure can be easily visualized such as a triangle, tree, pyramid, cone, or other geometric shape with a base and an apex. The display 100 can also be represented as a spiral or a ramp. The visual representation, in which the blocks at every level can be colored, allows the provider to analyze the results at different levels of detail. For example, when the provider sees that the value of the root block is negative, the provider can generally determine the cause or likely cause by looking at the more detailed levels of the geometric shape.

Base Blocks

The facts garnered from the questionnaires and then analyzed are grouped into blocks according to rules and determined by subject experts, incorporating the latest research results and clinical practice recommendations in a particular field of healthcare. Upon grouping these facts in their smallest subsets, the lowest echelon of the display 100 is, then, formed of blocks, in this nonlimiting exemplary display 100, to include a “General Medical History” block 111, an “Other Illness” block 113, a “Nutrition” block 115, a “Medications that Impair Balance” block 117, and a “Psychological Factors” block 119. As configured, the next echelon of blocks is based upon the first echelon. In the second echelon, a “Densitometry” block 121 rests upon the “General Medical History” block 111 and the “Other Illness” block 113. In a similar manner, a “Bone Wasting Medication” block 123 rests upon the “Other Illness” block 113 and the “Nutrition” block 115; a “Habits” block 125 rests upon the “Nutrition” block 115 and the “Medications that Impair Balance” block 117; and a “Physical Assessment” block 127 rests upon the “Medications that Impair Balance” block 117 and the “Psychological Factors” block 119. While the configuration of the display has been described, it ought to be clear that the arrangement of the blocks does not require that first the blocks upon which a second echelon block rests are neither the exclusive source, nor even necessarily the source of the data that will cause the coloration of the second echelon block. What is the case is that in a more general manner, many of the second echelon blocks draw at least some of their score from some of the first echelon blocks.

The experts are facilitated in creating algorithms or rules by means, in part, of dialogue boxes 95 such as that shown in FIG. 4, determine the coloration of the blocks in the row where the block is places as well as often contributing to coloration of some blocks in echelons above the block in question. Within the rules, blocks are assigned specific values based on scoring calculations for their constituent facts as set forth with reference to FIGS. 1, 2 and 3. The values can be coded and displayed visually, for example, as colors or shapes.

In other embodiments of the invention, based on their use in the calculations, facts may be classified into active and passive categories. An active fact is used in the calculations for the block to which it belongs. A passive fact does not take part in any calculations; it is used either for storing some identification information or to generate reports. The facts can be original or derived using logical or mathematical relationships. The data for the original facts are entered by the patient or provider as is also discussed above. The values of the derived facts are calculated using the values of the original or other derived facts. Within the exemplary display 100, a demonstration of coloration of blocks based upon derived facts may be advantageously reviewed.

As stated upon introduction, the current display 100 is configured, by way of non-limiting example, to illuminate a patient's bone fracture risks including those attributed to osteoporosis and, then, formulating the appropriate suggestions for prevention, treatment, and follow-up. The data is collected in this example using the specifically designed targeted dynamic questionnaires and upon collection and collation, are grouped into 15 blocks:
The “General Medical History” block 111 reflects risks from experiences and conditions of the patient and their effect as to amplifying or diminishing risk, including hormones and bone medications taken;
The “Other Illnesses” block 113 reflects current conditions not reflected completely in the “General Medical History” block 111;
The “Nutrition” block 115 includes such risks or diminution of risk based upon consumption of calcium and Vitamin D:
The “Medications that Impair Balance” block 117 indicates effects upon the risk;
The “Psychological Factors” block 119 reflects the increase or diminution of risk arising from a patient's psychological factors;
Beginning the second echelon, the “Densitometry” block 121 reflects objective evidence of known diminution of bone density upon the risk;
The “Bone-Wasting Medications” block 123 reflects the administration and use of such medications as have been identified in the medical literature;
The “Habits” block 125 reflects the known risks of patient habits as described above in conjunction with FIG. 2;
The “Physical Assessment” block 127 allows provider input identifying such risk determinants as the provider may visualize or detect upon examination;
Genetic factors that influence risk are incorporated in a “Fracture/Family History” block 131 to begin the third echelon;
Like the “Habits” block 125, a “Lifestyle” block 133 reflects such issues as might influence risk from regular recurrent patient activity or lack thereof such as might stem from regular participation in such activities as skiing or hiking, etc.;
Rather than activities the patient participates in, the “Living Conditions” block 135 reflects such risks inherent in the residence of patient such as the presence of stairs;
Aggregating a number of the factors from the lower echelons, the first fourth echelon block, a “Bone Health Forecast” block 141 reflects a prognosis of the patient's bone health;
A “Risk of Falling” block 143 depends on the age of the patient, values reflected in the lower echelons; and
The ultimate block, a “Fracture Risk” block 150 is the summary of the whole of the chart and its color or configuration relates directly to the values of the blocks immediately below it: “Bone Health Forecast” block 141 and “Risk of Falling” block 143.

The values of the blocks are coded as colors. There are four possible colors used in the presently preferred embodiment:

grey=0 (if no data is provided)

green=1 (no significantly increased risk of osteoporotic fracture)

yellow=2 (moderately increased risk of osteoporotic fracture)

red=3 (greatly increased risk of osteoporotic fracture)

The scores that cause the database to generate colors of blocks can be updated using the administrative interface to the system. This update capability makes it possible to keep the system up-to-date with ongoing changes in medical science or to accommodate an opposite view on a controversial area of diagnosis or treatment.

In a simpler example of the rules or algorithm-based coloration of blocks, the “Habits” block 125 presents many interesting features. The weight or score of the “Habits” block 125 is calculated as a sum of the weights for the selected options of the three questions 27, 35, and 41 (FIG. 2). If, for example, none of the answer options for a specific question is selected, the question is not used in calculating the weight of the block. If none of the answer options are selected for all of the questions, the color of the block is set to grey. Once the weight of the “Habits” block 125 is calculated based upon patient responses, those responses, when aggregated and weighted are compared to the ranges for the three colors (values). In the case of the Habits block, the ranges are (FIG. 4): up to −6 for red; between −6 and −3): for yellow; and greater than −3 for green. In the case shown in FIG. 5, the total weight is equal to −2 and the color of the “Habits” block 125 is accordingly assigned as green.

In the more complex case of the ultimate block, the “Fracture Risk” block, the weight or score is derived from both the “Bone Health Forecast” block 141 and the “Risk of Falling” block 143. As would be intuitive, risk of fracture is the product of bone health, the measure of the bone's inherent strength or resistance to fracture, and the likelihood that the bone will be damaged by a fall, the risk of falling. Thus, in the exemplary display 100, the “Fracture Risk” block is colored red in spite of the presence of green in a number of important blocks the presence of the several green blocks: “General Medical History” block 111, the “Habits” block 125, the “Physical Assessment” block 127, the “Lifestyle” block 133, the “Living Conditions” block 135, and the “Risk of Falling” block 143 simply cannot outweigh the effects of the dangers presented by the adverse “Bone Health Forecast” block 141.

In some cases, the logic for calculating the weight of a specific block may be more complex. Consider the example of the “Densitometry” block 131. According to the current osteoporosis standards, the densitometry examination result for a male over 50 years old or a post-menopausal female patient is determined using the following rules: if the T-score is less than −2.5, then the patient is osteoporotic; if the T-score is between −2.5 and −1.0, the patient has low bone density; if the T-score is more than −1.0, the patient has normal bone density. On the other hand, the rules for calculating the examination result for a male under 50 or a pre-menopausal female are based, not on the T-score, but the Z-score, as well as other parameters. The logic for calculating the weight of the “Densitometry” block will take these rules into account.

Still another complex algorithm is one nonlimiting example of that used to color the “Bone Health Forecast” block 141. The score and, thus, the color of the “Bone Health Forecast” block 141 is calculated based on the values of the following eight blocks:

“Fracture/Family History” block 131;

“Densitometry” block 121;

“Bone-Wasting Medications” block 123

“Habits” block 125;

“General Medical History” block 111;

“Other Illnesses” block 113;

“Nutrition” block 115; and

“Lifestyle” block 133.

The sum of the various scores of the individually listed blocks when compared against the algorithms determines the value of the “Bone Health Forecast” block 141. Likewise, the value of the “Risk of Falling” block 143 is calculated based on the values of the following six blocks:
“Lifestyle” block 133;
“Living Conditions” block 135;
“Habits” block 125;
“Physical Assessment” block 127;
“Mediations that Impair Balance” block 117; and
“Psychological Factors” block 119.

While the preferred embodiment of the invention has been illustrated and described, as noted above, many changes can be made without departing from the spirit and scope of the invention. For example, the display could have been used it show health and aging of inanimate capital property such as buildings or machinery. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method of generating a display reflecting some contents of a database, the display being configured for representing a plurality of diverse factors to determine a state of health, the method comprising:
retrieving, from the database, values representing each of a plurality of factors determined to be indicative of the state of health;
analyzing each of the retrieved values to determine a first score indicating conformity with corresponding identified first thresholds;
coloring each of a plurality of first blocks, each block corresponding to one of the plurality of factors, based upon the first score corresponding to the one of the plurality of factors;
selectively combining first scores to determine at least one second score based upon conformity with a corresponding plurality of identified second thresholds;
coloring each of the at least one second block based upon the second score to which the at least one block corresponds;
arranging the at least one second block in a second echelon of the display; and
arranging the plurality of first blocks to form a first echelon such that each of the first blocks is close to the second block that bases its second score upon that first block.

2. The display of claim 1, wherein the first thresholds are determined based upon medical knowledge derived from at least one of the group consisting of medical literature, medical experience, and medical knowledge.
